(19) United States
(12) Patent Application Publication
(10) Pub. No.: US 2005/0069182 A1
(43) Pub. Date: Mar. 31, 2005

(54) Finger scanner and method of scanning a finger

(76) Inventors: John K. Schneider, Snyder, NY (US); Jack C. Kitchens, Buffalo, NY (US)

Correspondence Address: HODGSON RUSS LLP, ONE M & T PLAZA, SUITE 2000, BUFFALO, NY, 14203-2391, US

(21) Appl. No.: 10/952,403

(22) Filed: Sep. 28, 2004

Related U.S. Application Data
(60) Provisional application No. 60/507,367, filed on Sep. 30, 2003.

(51) Int. Cl. G06K 9/00

(52) U.S. Cl. 382/126

(57) ABSTRACT

The invention includes a finger scanner having an energy emitter, an analyzing surface, and a resting surface. The invention also includes a method of scanning a finger.

### CROSS-REFERENCE TO RELATED APPLICATION

This application claims the benefit of priority to U.S. provisional patent application Ser. No. 60/507,367, filed on Sep. 30, 2003.

### FIELD OF THE INVENTION

The invention relates to finger scanners, such as an ultrasonic finger scanner. Such scanners are often used to provide information about a finger print corresponding to a finger. In particular, the invention relates to devices and methods of aligning a finger to be analyzed so that information about finger prints may be obtained in a repeatable manner.

### BACKGROUND OF THE INVENTION

Finger scanners often include an imaging surface on which is placed a finger to be analyzed. One such imaging surface is transparent to energy emitted from an acoustic or electromagnetic wave emitter. An acoustic wave emitter may emit ultrasonic energy. An electromagnetic wave emitter may emit infrared, light or ultraviolet energy. A portion of the emitted energy may be reflected from the finger to a receiver. The receiver may use the reflected energy to provide information about the surface, in this case a finger. The information may be put in a form that is recognizable as a fingerprint image.

Other methods of obtaining information about a finger use imaging surfaces that are designed to obtain information using piezoresistive, capacitive, piezocapacitive, thermal, contact resistance, conductivity, moisture, inductive, or RF injection technology to obtain information about a finger.

Often, the image produced by a finger scanner is a poor match to an image taken using conventional ink-and-paper techniques. A reason for the poor match is that the person being fingerprinted, especially in an unattended situation, has a tendency to apply the finger to the imaging surface in a manner so as to provide the extreme side of the finger for scanning. Another problem is that some people have a tendency to apply the finger to the imaging surface in a manner so as to provide the extreme tip of the finger for scanning.

### SUMMARY OF THE INVENTION

The invention may include a finger scanner having (a) an energy emitter, (b) an analyzing surface, and (c) a resting surface. The energy emitter may provide analyzing energy to the analyzing surface. The analyzing surface may be translucent to the analyzing energy so that at least some of the analyzing energy is allowed to pass through the analyzing surface. The analyzing surface may be shaped to receive at least a portion of a first finger to be analyzed. The resting surface may be positioned relative to the analyzing surface so as to cause the first finger to be positioned on the analyzing surface so as to allow the first finger to be analyzed in a desired manner.

### BRIEF DESCRIPTION OF THE DRAWINGS

For a fuller understanding of the nature and objects of the invention, reference should be made to the accompanying drawings and the subsequent description. Briefly, the drawings are:

FIG. 1, which is a perspective view of a finger scanner according to the invention, and a portion of a housing is cut away to illustrate an energy emitter;

FIG. 2, which is a perspective view of a finger scanner according to the invention;

FIG. 3, which is a perspective view of a finger scanner according to the invention;

FIG. 4, which is a perspective view of a finger scanner according to the invention;

FIG. 5, which is a perspective view of a finger scanner according to the invention;

FIG. 6, which is a perspective view of the finger scanner shown in FIG. 5;

FIG. 7, which is a plan view of the finger scanner shown in FIG. 5;

FIG. 8, which is a side view of the finger scanner shown in FIG. 7;

FIG. 9, which is a perspective view of a finger scanner according to the invention;

FIG. 10, which is a perspective view of the finger scanner shown in FIG. 9;

FIG. 11, which is a plan view of the finger scanner shown in FIG. 9;

FIG. 12, which is a side view of the finger scanner shown in FIG. 11;

FIG. 13, which is a perspective view of a finger scanner according to the invention;

FIG. 14, which is a perspective view of the finger scanner shown in FIG. 13;

FIG. 15, which is a plan view of the finger scanner shown in FIG. 13;

FIG. 16, which is a side view of the finger scanner shown in FIG. 15;

FIG. 17, which is a perspective view of a finger scanner according to the invention;

FIG. 18, which is a perspective view of the finger scanner shown in FIG. 17;

FIG. 19, which is a plan view of the finger scanner shown in FIG. 17;

FIG. 20, which is a side view of the finger scanner shown in FIG. 19;

FIG. 21, which is a perspective view of a finger scanner according to the invention;

FIG. 22, which is a perspective view of the finger scanner shown in FIG. 21;

FIG. 23, which is a plan view of the finger scanner shown in FIG. 21;

FIG. 24, which is a side view of the finger scanner shown in FIG. 23;

FIG. 25, which is a perspective view of a finger scanner according to the invention;

FIG. 26, which is a perspective view of the finger scanner shown in FIG. 25;

FIG. 27, which is a plan view of the finger scanner shown in FIG. 25;

FIG. 28, which is a side view of the finger scanner shown in FIG. 27; and

FIG. 29, which shows steps of a method according to the invention.

### FURTHER DESCRIPTION OF THE INVENTION

A scanner according to the invention may include one or more resting surfaces. The resting surface may provide a location on which to rest a finger, which is not the finger being analyzed. By requiring one finger to be applied to the imaging surface and another finger to be applied to the resting surface, the tendency to roll the finger being analyzed, to one side or the other, is reduced or eliminated. Additionally, since fingers on one hand are normally not the same length, the tendency for the person being fingerprinted to place the extreme tip of a finger onto the imaging surface is reduced or eliminated. In this manner, the finger being analyzed is placed on the imaging surface in a repeatable manner. Consequently, the finger being analyzed is less likely to be tilted to one side or the other, and is less likely to be presented at an angle so steep as to allow only the extreme fingertip to be scanned. With these two finger placement extremes prevented, fingerprints acquired from the scanner may be centered and of sufficient area, so that matching to information in a fingerprint database may occur more easily than with existing finger scanners.

The resting surface may include a trough. The trough may be shaped to comfortably receive a finger that is not being analyzed. The resting surface may be placed adjacent to the imaging surface. More than one resting surface may be provided, and these may be provided on different sides, or on the same side, of the imaging surface. The resting surface may be positioned so that when the subject being fingerprinted places his or her fingers on the resting surface, the finger being analyzed will be comfortably positioned on the imaging surface.

Having provided a general description of embodiments of the invention, a more detailed description of embodiments of the invention is provided below.

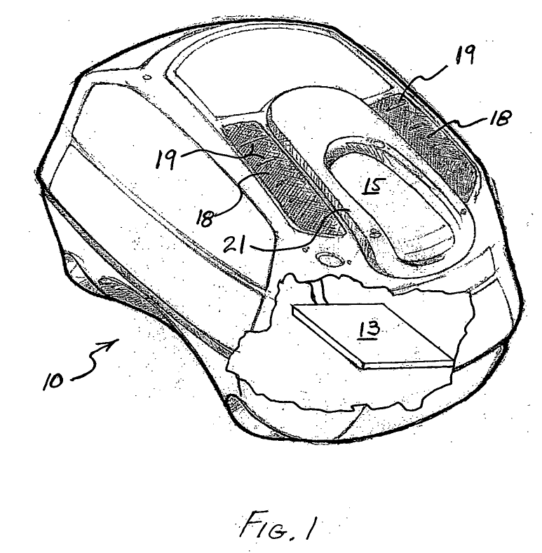

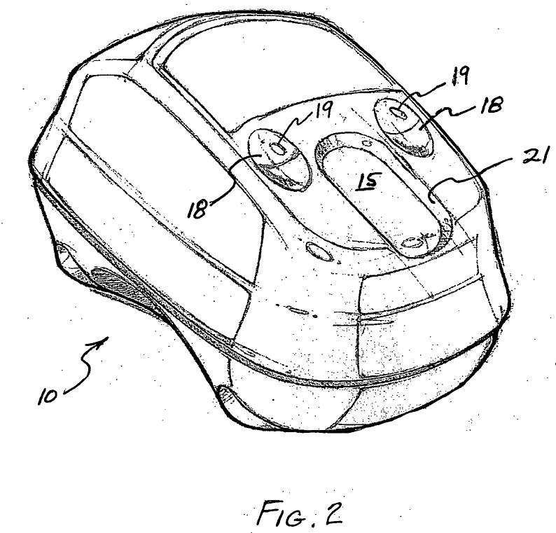

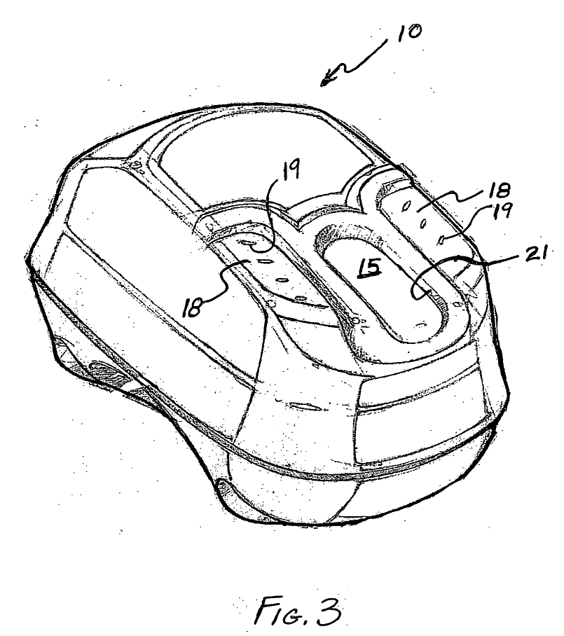

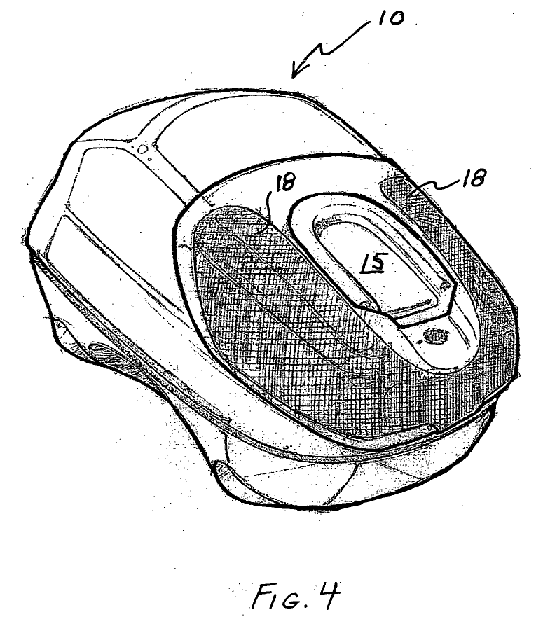

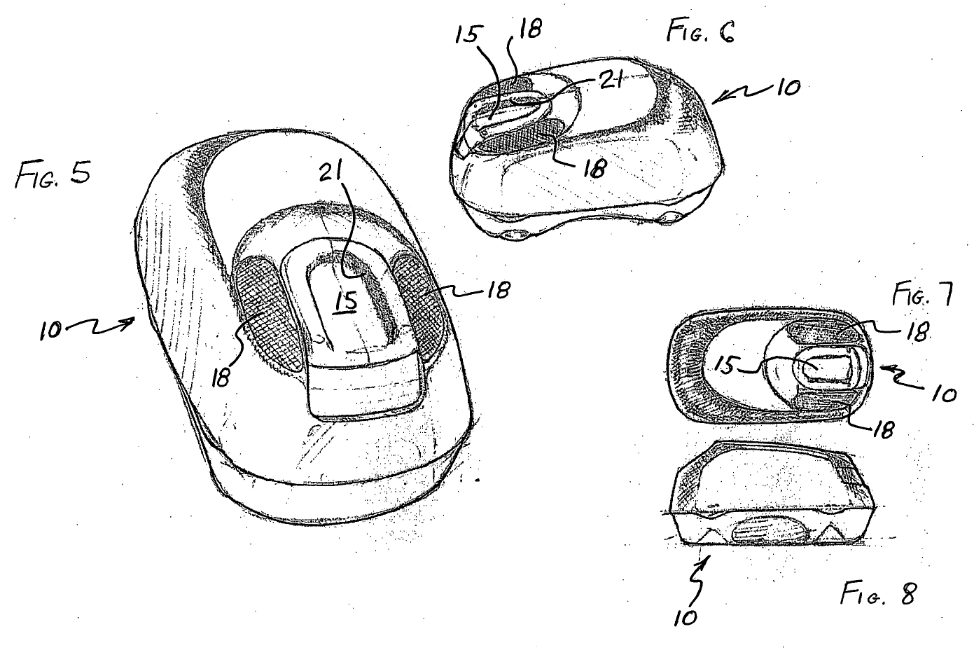

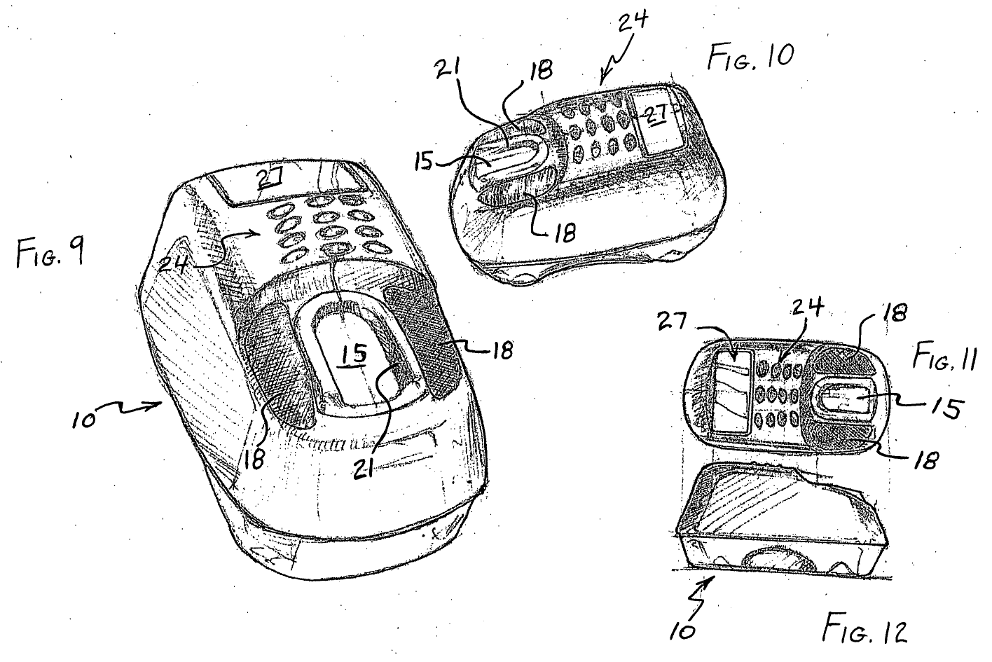

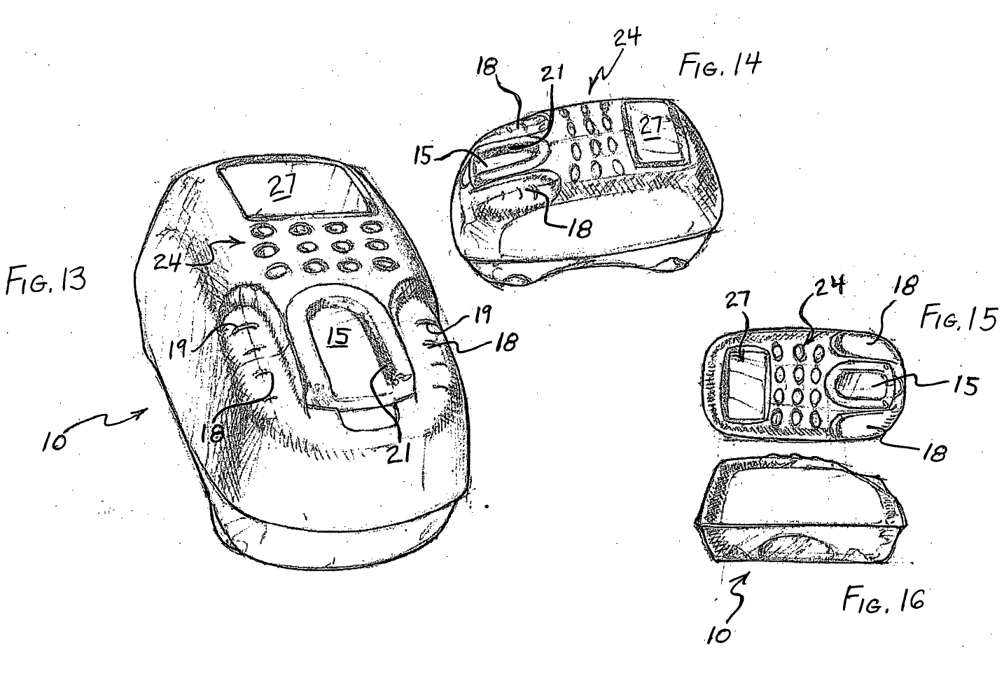

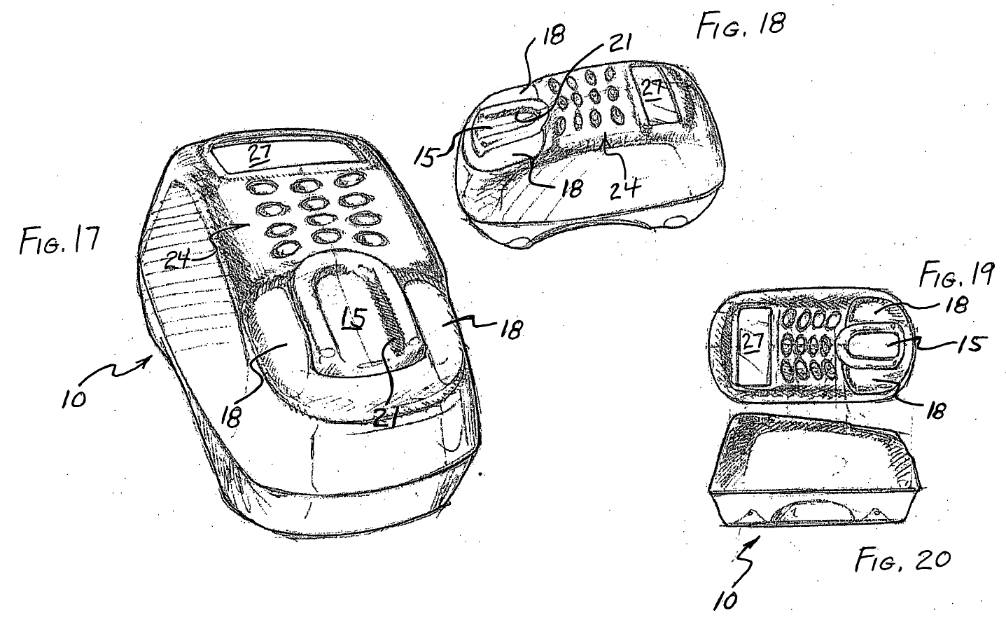

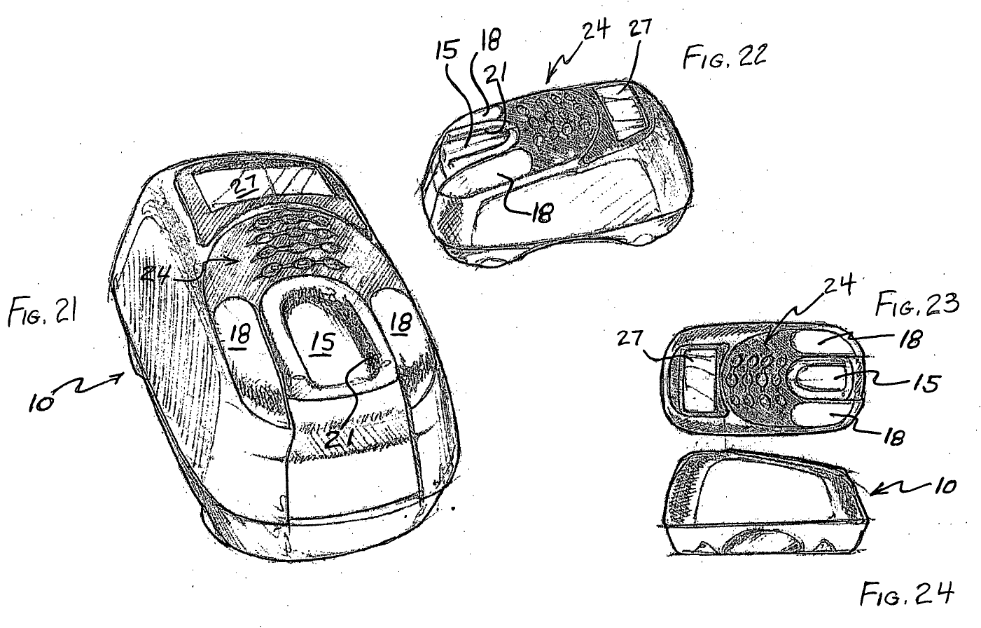

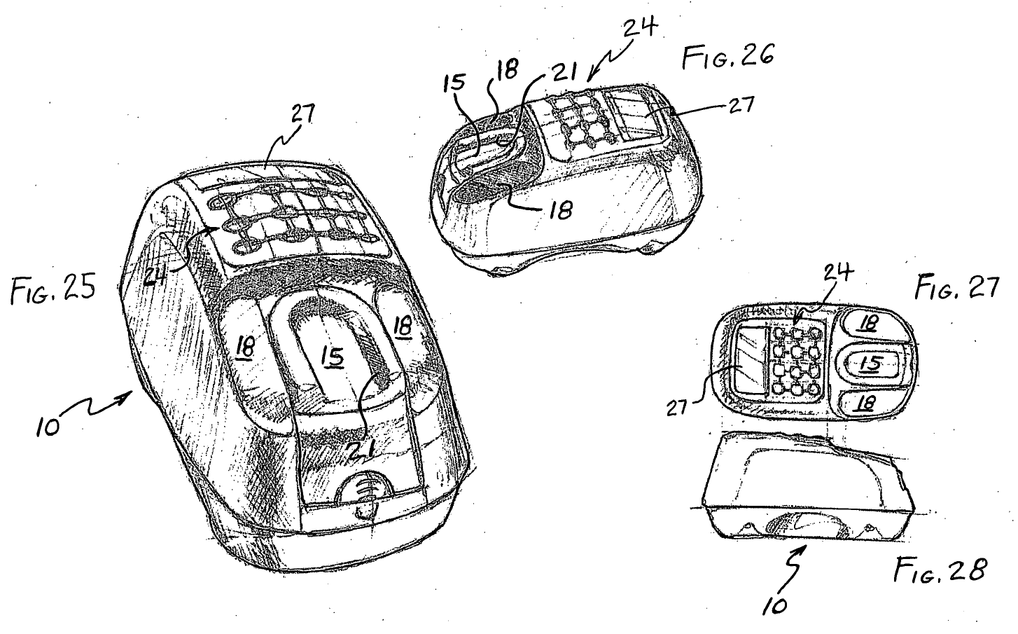

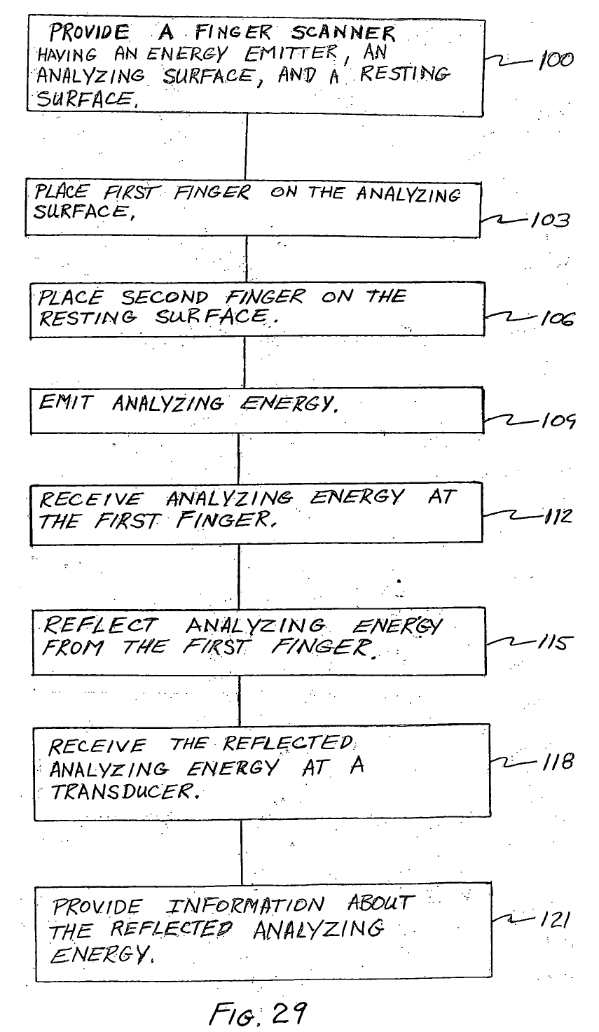

FIG. 1 depicts an embodiment of the invention. In FIG. 1 there is a finger scanner 10 having an energy emitter 13, which is capable of providing analyzing energy. The embodiments depicted in FIGS. 2 through 28 also include an energy emitter, but the emitter is not shown in FIGS. 2 through 28. For example, the energy emitter 13 may emit ultrasonic energy. It should be noted that the invention is not limited to devices having ultrasonic energy emitters 13. The finger scanner 10 is also shown having an analyzing surface 15 and a resting surface 18. More than one resting surface 18 may be provided. FIGS. 2 through 28 show nine additional embodiments of the invention.

The analyzing surface 15 may be translucent to analyzing energy and positioned with respect to the energy emitter 13 so that analyzing energy may be received by the analyzing surface 15. The analyzing surface 15 may be shaped to receive at least a portion of a first finger to be analyzed.

The finger scanner 10 is shown having a resting surface 18 proximate to the analyzing surface 15. The resting surface 18 may be shaped to receive at least a portion of a second finger that is not to be analyzed. The resting surface 18 may be positioned relative to the analyzing surface so as to cause the first finger to be properly positioned on the analyzing surface 15, in order to allow the first finger to be analyzed. The resting surface 18 may be provided to have a concave shape in order to make use of the resting surface 18 more comfortable, and to assist in proper placement of a finger on the resting surface 18. The resting surface 18 may also be textured and/or may include bumps 19 to prevent movement of the finger, and thereby reduce movement of the finger placed on the analyzing surface 15.

The analyzing surface 15 and the resting surface 18 may be provided at different elevations. FIGS. 2 through 4 show such an arrangement. FIGS. 1 and 5 through 20 show devices according to the invention in which the analyzing surface 15 and the resting surface 18 are provided at approximately the same elevation.

A finger scanner 10 according to the invention may include a ridge 21 between the resting surface 18 and the analyzing surface 15. The ridge 21 may be of sufficient height to prevent fingers that are not being analyzed from being placed on the analyzing surface 15. The ridge 21 may be provided to partially surround the analyzing surface 15.

A finger scanner 10 according to the invention may include additional security features. For example, a plurality of buttons 24 may be provided on the finger scanner 10 and used to input information, such as a name or identification number. FIGS. 9 through 28 show finger scanners 10 with a plurality of buttons 24. The finger scanner may correlate the fingerprint information with information provided via the buttons, and thereby provide greater certainty about the individual providing the fingerprint information.

A finger scanner 10 according to the invention may include a display screen 27. The display screen may be a liquid crystal display. The display screen may be used to communicate with a person using the scanner, for example, to provide instructions to the person.

The invention may include a method of providing information about a finger. For example, a method according to the invention may begin by providing 100 a finger scanner having (a) an energy emitter capable of providing analyzing energy, (b) an analyzing surface that is translucent to analyzing energy and positioned with respect to the energy emitter so that analyzing energy may be received by the analyzing surface, and (c) a resting surface proximate to the analyzing surface. A first finger may be placed 103 on the analyzing surface, and a second finger may be placed 106 on the resting surface so as to cause a central portion of the first finger to be positioned on the analyzing surface in a location which receives analyzing energy. Analyzing energy may be emitted 109 from the emitter, and received 112 at the first finger. The analyzing energy may be reflected 115 from the first finger and received 118 at a transducer. The transducer may then provide 121 information about the reflected analyzing energy, for example, in a form that may be interpreted as a finger print.

Although the invention has been described with respect to one or more particular embodiments, it will be understood that other embodiments of the invention may be made without departing from the spirit and scope of the invention. Hence, the invention is deemed limited only by the appended claims and the reasonable interpretation thereof.

1. A finger scanner, comprising:
an energy emitter capable of providing analyzing energy;
an analyzing surface that is translucent to analyzing energy and positioned with respect to the energy emitter so that analyzing energy may be received by the analyzing surface, the analyzing surface being shaped to receive at least a portion of a first finger to be analyzed;
a resting surface proximate to the analyzing surface and shaped to receive at least a portion of a second finger that is not to be analyzed; the resting surface being positioned relative to the analyzing surface so as to cause the first finger to be positioned on the analyzing surface so as to allow the first finger to be analyzed in a desired manner.

2. The finger scanner of claim 1, wherein the analyzing surface and the resting surface are at different elevations.

3. The finger scanner of claim 1, wherein the resting surface is concave.

4. The finger scanner of claim 1, further comprising another resting surface, wherein the resting surface proximate to the analyzing surface and the another resting surface are positioned on different sides of the analyzing surface.

5. The finger scanner of claim 1, further comprising a ridge between the resting surface and the analyzing surface.

6. The finger scanner of claim 1, wherein the resting surface includes a textured surface.

7. The finger scanner of claim 1, further comprising a ridge partially surrounding the analyzing surface.

8. The finger scanner of claim 1, wherein the analyzing energy is comprised of ultrasonic energy.

9. A method of providing information about a finger, comprising:
providing a finger scanner having (a) an energy emitter capable of providing analyzing energy, (b) an analyzing surface that is translucent to analyzing energy and positioned with respect to the energy emitter so that analyzing energy may be received by the analyzing surface, and (c) a resting surface proximate to the analyzing surface;
placing a first finger on the analyzing surface;
placing a second finger on the resting surface so as to cause a central portion of the first finger to be positioned on the analyzing surface in a location which receives analyzing energy;
emitting analyzing energy from the emitter;
receiving the analyzing energy at the first finger;
reflecting the analyzing energy from the first finger;
receiving the reflected analyzing energy;
providing information about the reflected analyzing energy.
